(19) United States
(12) Patent Application Publication
(10) Pub. No.: US 2026/0105462 A1
(43) Pub. Date: Apr. 16, 2026

(54) FRAMEWORK FOR INDUSTRY-SPECIFIC ARTIFICIAL INTELLIGENCE AGENT

(71) Applicant: Podium Corporation, Inc., Lehi, UT (US)

(72) Inventors: Craig Walker Ward, Lehi, UT (US); Timothy Stewart Milliron, Austin, TX (US); Jiovan Andre Melendez, Highland, UT (US); Rishit Gautam Shah, Sunnyvale, CA (US)

(21) Appl. No.: 18/912,439

(22) Filed: Oct. 10, 2024

(51) Int. Cl. G06Q 30/015; G06F 40/35; G06F 40/40; H04L 51/02

(52) U.S. Cl. CPC G06Q 30/015; G06F 40/35; G06F 40/40; H04L 51/02

(57) ABSTRACT

Methods, systems, apparatuses, devices, and computer program products are described. An event associated with a contact of a first organization may be detected. Based on the detected event and a conversation associated with the contact, an intended outcome of the conversation may be identified and a first industry-specific playbook may be selected. One more steps associated with the first industry-specific playbook may be executed and a prompt may be generated. The prompt may include information associated with the detected event, information obtained based on performance of the one or more steps, and information associated with the intended outcome. Based on input of the prompt to a large language model (LLM), information associated with a response to the detected event may be obtained and one or more actions may be performed based on the information associated with the response.

### FIELD OF TECHNOLOGY

The present disclosure relates generally to communications system, and more specifically to a framework for an industry-specific artificial intelligence (AI) agent.

### BACKGROUND

A customer interaction system may be employed by an organization to communicate and interact with users. Some customer interaction systems may utilize an artificial intelligence (AI) agent to interact with users through natural language conversation. However, many AI agents lack the ability to integrate context from various channels, previous interactions, and industry-specific data sources and tools and, thus, often fall short in understanding ambiguous or complex inquiries, leading to unsatisfactory customer experiences. In addition, some AI agents may be question/answer-oriented and may lack an ability to steer a conversation or interact with a user towards a specific outcome.

### SUMMARY

The described techniques relate to improved methods, systems, devices, and apparatuses that support a framework for an industry-specific artificial intelligence agent.

A method for operating an artificial intelligence (AI) agent by an apparatus is described. The method may include detecting an event associated with a contact of a first organization, identifying, based at least in part on the detected event and a conversation associated with the contact, an intended outcome of the conversation, selecting, based on the intended outcome and the first organization, a first industry-specific playbook of a set of multiple industry-specific playbooks, executing one or more steps associated with the first industry-specific playbook, where the one or more steps are selected based on the detected event and the conversation, generating, based on the first industry-specific playbook, a first prompt that includes first information associated with the detected event, second information obtained based on performance of the one or more steps, and third information associated with the intended outcome, obtaining, based at least in part on inputting the first prompt to a first large language model (LLM), fourth information associated with a response to the detected event, and performing, based on the fourth information, one or more actions.

An apparatus for utilizing an artificial intelligence (AI) agent is described. The apparatus may include one or more memories storing processor executable code, and one or more processors coupled with the one or more memories. The one or more processors may individually or collectively be operable to execute the code to cause the apparatus to detect an event associated with a contact of a first organization, identifying, based at least in part on the detected event and a conversation associated with the contact, an intended outcome of the conversation, select, based on the intended outcome and the first organization, a first industry-specific playbook of a set of multiple industry-specific playbooks, execute one or more steps associated with the first industry-specific playbook, where the one or more steps are selected based on the detected event and the conversation, generate, based on the first industry-specific playbook, a first prompt that includes first information associated with the detected event, second information obtained based on performance of the one or more steps, and third information associated with the intended outcome, obtain, based at least in part on inputting the first prompt to a first large language model (LLM), fourth information associated with a response to the detected event, and perform, based on the fourth information, one or more actions.

Another apparatus for utilizing an artificial intelligence (AI) agent is described. The apparatus may include means for detecting an event associated with a contact of a first organization, means for identifying, based at least in part on the detected event and a conversation associated with the contact, an intended outcome of the conversation, means for selecting, based on the intended outcome and the first organization, a first industry-specific playbook of a set of multiple industry-specific playbooks, means for executing one or more steps associated with the first industry-specific playbook, where the one or more steps are selected based on the detected event and the conversation, means for generating, based on the first industry-specific playbook, a first prompt that includes first information associated with the detected event, second information obtained based on performance of the one or more steps, and third information associated with the intended outcome, means for obtaining, based at least in part on inputting the first prompt to a first large language model (LLM), fourth information associated with a response to the detected event, and means for performing, based on the fourth information, one or more actions.

A non-transitory computer-readable medium storing code for utilizing an artificial intelligence (AI) agent is described. The code may include instructions executable by one or more processors to detect an event associated with a contact of a first organization, identifying, based at least in part on the detected event and a conversation associated with the contact, an intended outcome of the conversation, select, based on the intended outcome and the first organization, a first industry-specific playbook of a set of multiple industry-specific playbooks, execute one or more steps associated with the first industry-specific playbook, where the one or more steps are selected based on the detected event and the conversation, generate, based on the first industry-specific playbook, a first prompt that includes first information associated with the detected event, second information obtained based on performance of the one or more steps, and third information associated with the intended outcome, obtain, based at least in part on inputting the first prompt to a first large language model (LLM), fourth information associated with a response to the detected event, and perform, based on the fourth information, one or more actions.

In some examples of the method, apparatus, and non-transitory computer-readable medium described herein, the detected event includes an email, a text message, a telephone call, a scheduling event, or a previous conversation associated with the contact.

In some examples of the method, apparatus, and non-transitory computer-readable medium described herein, performing the one or more actions may include operations, features, means, or instructions for updating, based on determining that the intended outcome may have been achieved, a state of the conversation to a concluded state, outputting a question to the contact to solicit information to the conversation towards the intended outcome, determining whether a response to an unanswered query output to the contact may be needed for arriving at the intended outcome, scheduling a second event associated with the contact, and a combination thereof.

Some examples of the method, apparatus, and non-transitory computer-readable medium described herein may further include operations, features, means, or instructions for classifying, using a second LLM and based on the first information and on information associated with the first organization, the detected event, where the first industry-specific playbook may be selected further based on classification of the detected event.

In some examples of the method, apparatus, and non-transitory computer-readable medium described herein, the second LLM may be the same as the first LLM.

Some examples of the method, apparatus, and non-transitory computer-readable medium described herein may further include operations, features, means, or instructions for determining an industry associated with the first organization, where one or more of the first industry-specific playbook or the intended outcome may be selected based on the industry associated with the first organization.

Some examples of the method, apparatus, and non-transitory computer-readable medium described herein may further include operations, features, means, or instructions for determining contextual information, where the contextual information includes one or more of information associated with an environmental state, a current date, a current time, information associated with the first organization, information associated with the contact, information associated with a client device associated with the contact, information associated with the conversation, a first communications channel associated with the detected event, or a second communications channel associated with the response to the detected event, and where the one or more steps may be selected further based on the contextual information.

In some examples of the method, apparatus, and non-transitory computer-readable medium described herein, the first communications channel includes email, text, chat, social media, a website input field, or voice call, the conversation may be received via the first communications channel, and determining the contextual information includes determining a portion of the contextual information based on the conversation received via the communications channel.

Some examples of the method, apparatus, and non-transitory computer-readable medium described herein may further include operations, features, means, or instructions for determining a previous communications channel associated with a previous event associated with the conversation, where the previous communications channel may be different from the first communications channel, and where determining the contextual information includes determining the contextual information based on a conversation associated with the previous communications channel.

Some examples of the method, apparatus, and non-transitory computer-readable medium described herein may further include operations, features, means, or instructions for retrieving and executing one or more activation tools or knowledge tools, and where the second information obtained based on the performance of the one or more steps includes information retrieved from execution of the one or more activation tools or knowledge tools.

Some examples of the method, apparatus, and non-transitory computer-readable medium described herein may further include operations, features, means, or instructions for selecting the first industry-specific playbook may be based on determining that the detected event satisfies a discontinuation policy, a filter policy, or a combination thereof.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE DRAWINGS

FIG. 1 illustrates an example of a communications system that supports a framework for an industry-specific artificial intelligence (AI) agent in accordance with aspects of the present disclosure.

FIGS. 2 and 3 show examples of process flows that support a framework for an industry-specific AI agent in accordance with aspects of the present disclosure.

FIG. 4 shows a block diagram of an apparatus that supports a framework for an industry-specific AI agent in accordance with aspects of the present disclosure.

FIG. 5 shows a flowchart illustrating methods that support a framework for an industry-specific AI agent in accordance with aspects of the present disclosure.

### DETAILED DESCRIPTION

Some customer interaction systems may utilize an artificial intelligence (AI) agent (e.g., an AI conversational agent) to interact with users of an organization using natural language conversation. However, many AI agents lack the ability to integrate context from various channels, previous interactions, and industry-specific data sources, and thus often fall short in understanding ambiguous or complex inquiries, leading to unsatisfactory customer experiences. In addition, some AI agents may be question/answer-oriented and may lack an ability to steer a conversation or interact with a user towards a specific outcome.

In accordance with aspects described herein, a domain or industry-specific AI agent may use one or more large language models (LLMs) to perform complex and domain-specific tasks while adhering to business rules and policies associated with an organization. The AI agent may deconstruct received user queries, requests, or other interactions into manageable units of instructions in order to guide AI behavior, to not only be responsive to such user queries and requests, but to also flexibly navigate the user interaction towards a particular desired or intended outcome. In some cases, such outcomes may be specific to the industry or domain associated with the organization. Organizations may leverage such AI agents to execute, for example, employee tasks in customer-facing roles where adherence to specific protocols and business logic may be important. By providing a structured and context-aware AI agent, a customer interaction system may adaptably support a diverse range of user interaction scenarios, while maintaining consistency and adherence with organizational guidelines. In accordance with aspects described herein, a framework is provided for integration of industry-specific playbooks with LLMs, enabling AI agents to conduct context-aware, outcome-driven conversations. By leveraging multiple communications channels and historical interactions, the AI agent may be capable of understanding ambiguous or complex inquiries and guide users toward specific objectives. This may result in improved customer experiences and operational efficiency over existing AI agents.

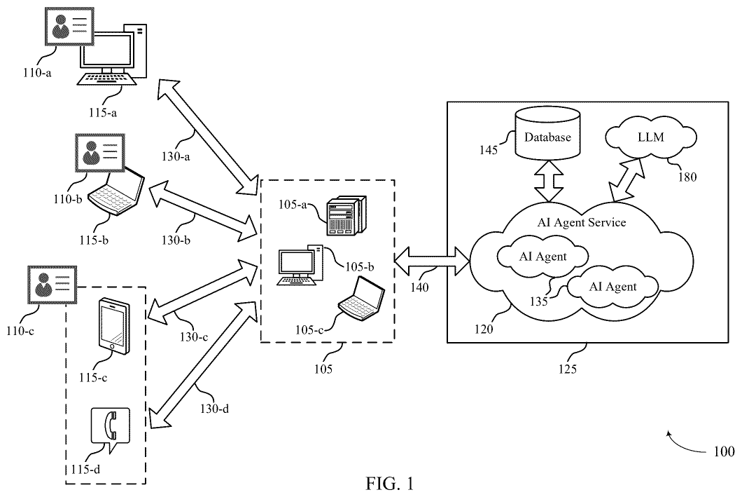

FIG. 1 illustrates an example of a communications environment 100 that supports a framework for an industry-specific AI agent in accordance with various aspects of the present disclosure. The communications environment 100 may include one or more client devices 105, one or more contacts 110, one or more contact devices 115, and a communications platform 125.

The one or more client devices 105 may access the communications platform 125 over a network connection 140. The network connection 140 may implement transfer control protocol and internet protocol (TCP/IP), such as the Internet, or may implement other network protocols. The client devices 105 may be examples of devices associated with one or more organizations (e.g., a business, an enterprise, a non-profit, or any other type of organization) that utilize one or more services or resources provided by the communications platform 125. For instance, a client device 105 may be a server or other machine (e.g., first client device 105-a), such as a physical machine, a virtual machine, a physical server, a virtual (e.g., cloud) server, a data center, or the like. In some cases, the first client device 105-a may be a virtualized server (e.g., virtualized machine) running in a cloud computing environment that is hosted and managed by a third-party service provider that may provide one or more services, such as infrastructure or other services, to various organizations. In some cases, the client device 105 may be a smartphone (e.g., second client device 105-b), a laptop (e.g., third client device 105-c), or any other type of computing device capable of generating, analyzing, transmitting, or receiving communications. In some examples, the client devices 105 may be operated by users or administrators of the respective organization. Each of the client devices 105 may interact with one or more contact devices 115 associated with the contacts 110.

The contacts 110 may be customers, potential customers, leads, etc. of the organizations associated with client devices 105, and the contact devices 115 may be devices (e.g., user devices) utilized by the contacts 110 to interact with the client devices 105. In some cases, a single contact 110 may utilize multiple different contact devices 115 to interact with one of the client devices 105. For instance, a first contact 110-a may utilize a computer (e.g., first contact device 115-a), a second contact 110-b may utilize a laptop (e.g., a second contact device 115-b), and a third contact 110-c may utilize a smartphone (e.g., a third contact device 115-c) and a telephone (e.g., a fourth contact device 115-d). In some cases, other types of contact devices 115 may be utilized to interact with one of the client devices 105.

The interactions between the client devices 105 and the contact devices 115 may include conversations, communications, purchases, sales, or any other type of interaction capable of occurring between devices, and may involve the transmission of various forms of data (e.g., text, images, audio, video, voice data, etc.) between the devices. The interactions may occur via one or more communications channels 130 between the contact devices 115 and the client devices 105. For instance, the contacts 110 may use their respective contact devices 115 to interact with the client devices 105 via various communications channels 130 that may be associated with communicating email messages, text messages, chat messages, social media messages/postings, website data (e.g., via a website input field), voice calls, or any other types of communications channel. For example, communications channels 130-a, 130-b, and 130-c may be used for communicating email messages, text messages, chat messages, social media messages/postings, or website data, while communications channel 130-d may be used for voice calls.

The communications platform 125 may provide one or more services or resources to the organizations. For instance, the communications platform 125 may provide the organizations with customer relationship management (CRM) solutions. This may include support for lead generation, customer engagement, reputation management, payment solutions, analytics, and the like. For example, the communications platform 125 may provide an AI agent service 120. The AI agent service 120 may implement one or more conversational AI agents 135 that may be used by the organizations to interact with their respective contacts 110.

In some implementations, the one or more AI agents 135 may be industry or domain-specific and may engage in natural language conversations with the contacts 110 to respond to user queries or perform tasks specific to a particular industry or domain with which the organization is associated. For instance, the AI agent service 120 may implement or provide different AI agents 135 that are specific to different domains, and the organizations may utilize those AI agents 135 that correspond to the organizations' particular industry. For example, the AI agent service 120 may provide AI agents 135 specific to the automotive field, the healthcare field, the home services field, the retail field, etc. Each of the AI agents 135 may implement or be an example of a generative AI system or other type of system that supports foundational and fine-tuned machine learning models (e.g., pre-trained machine learning models), such as large language models (LLMs). For instance, each of the AI agents 135 may incorporate capabilities of, or may utilize, one or more LLMs 180 trained on data specific to a corresponding domain that the AI agent 135 supports to perform domain-specific tasks. As such, each AI agent 135 may be tailored to handle specific tasks relevant to its industry or domain. For instance, an AI agent 135 that is specific to the automotive field may perform tasks associated with sales inquiries, such as providing information related to vehicle availability, scheduling test drives, responding to maintenance service requests, and the like. An AI agent 135 that is specific to the healthcare field may perform tasks associated with appointment scheduling, responding to patient-related inquiries, and the like. The AI agents 135 may be enabled with multi-modality capabilities that allows the AI agents 135 to support (e.g., process or generate) different types of data. For instance, the AI agents 135 may be capable of supporting text, audio, video, images, or other types of data. The AI agents 135 may be capable of integrating the different types of data in order to handle complex tasks. The AI agents 135 may be capable of detecting, processing, and generating responses or data in multiple languages. The AI agents 135 may be further capable of switching languages during the course of an interaction with a contact 110 based on detecting a change in a language being communicated by the contact 110. The LLM(s) 180 may be hosted within a same computing system (e.g., private LLM deployment) as AI agent service 120, or may be hosted within a separate computing system from the AI agent service 120.

Accordingly, the AI agents 135 may receive (e.g., at the AI agent service 120) data (e.g., text, audio, video, images, etc.) from, or generate and transmit data (e.g., text, audio, video, images, etc.) to, one or more of the client devices 105. The data may be associated with the interactions (e.g., a conversation) between the client devices 105 and their respective contact devices 115 (e.g., interactions between the client devices 105 and the contact devices 115 over the one or more communications channels 130). The data may be communicated between the AI agent service 120 and the client devices 105 via a network connection 140. The AI agents 135 may utilize the data from the interactions to respond to the user queries or perform domain-specific tasks. In some cases, the AI agent service 120 may process and store the data in one or more databases, such as a database 145. In some cases, the AI agent service 120 may, additionally, retrieve data from the database 145 to be utilized in responding to user queries or performing the domain-specific tasks. In some implementations, the AI agent service 120 (or a portion thereof) or the database 145 may be implemented at the client devices 105. In such cases, the AI agents 135 may directly communicate with the contact devices 115, such as via the one or more communications channels 130. In some implementations the AI agent service 120 may be implemented in a cloud-based environment, such as at a cloud-based virtual machine.

The AI agent service 120 may utilize multi-layered classification techniques to deconstruct the received user queries or other interactions into manageable units of context-specific instructions that are coupled with business rules and policies that guide an AI agent to generate responses that are both responsive to the received user queries (e.g., continuing a conversation as a dialog) and that steer the user interactions (e.g., to guide the conversation) towards a particular desired or intended outcome. In some cases, the AI agent service 120 may iteratively feedback user responses and other information, such as contextual information, information acquired from current or previous interactions, information retrieved from industry-specific data sources, etc., to the AI agent 135 to generate response and steer the user interactions towards the intended outcome. In some examples, an AI agent 135 may make multiple (e.g., iterative) calls (e.g., prompt inputs) to an LLM 180, where information obtained as a result of a first call may be part of a prompt used in a second call. Iterative calls to the LLM 180 may allow the AI agent to make more specific and tailored requests to the LLM 180, which may improve the results obtained from the LLM 180 and may allow the AI agent 135 to maintain focus of the results obtained from the LLM 180 on an intended outcome. In some cases, such outcomes may be specific to the industry or domain associated with the organization or may be specific to the organization itself. Such dynamic orchestration may enable the AI agent 135 to handle a wide range of scenarios while maintaining alignment with organizational policies, objectives, and standards.

It should be appreciated by a person skilled in the art that one or more aspects of the disclosure may be implemented in a communications environment 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

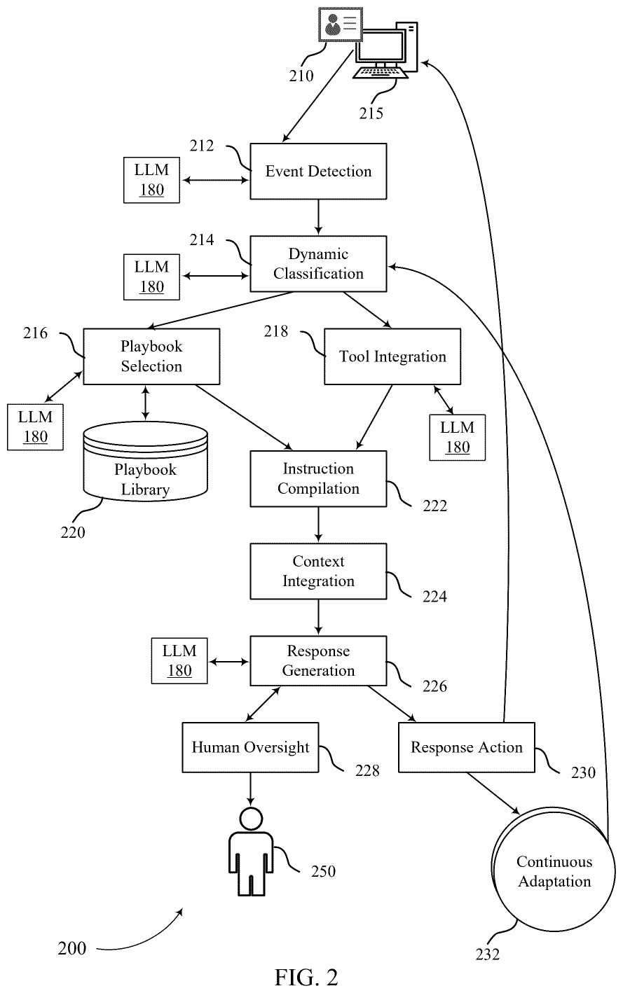

FIG. 2 illustrates an example of a process flow 200 that supports a framework for an industry-specific AI agent in accordance with aspects of the present disclosure. The process flow 200 may implement, or be implemented by, aspects of the communications environment 100 described with reference to FIG. 1. For instance, the process flow 200 may describe a framework for utilizing an AI agent 135 (e.g., provided by the AI agent service 120 of FIG. 1) by, for example, a first organization to interact with a contact 210 of the first organization via a contact device 215. The contact 210 and the contact device 215 may be examples of the contact 110 and the contact device 115 described with reference to FIG. 1. The process flow 200 may involve a series of interconnected steps that allow for dynamic and adaptive interaction flow (e.g., a conversation flow) between the contact 210 and the AI agent 135 of the AI agent service 120. For instance, in some implementations, the AI agent 135 or the AI agent service 120 may iteratively call one or more LLMs 180. For instance, the AI agent 135 or the AI agent service 120 may call an LLM 180 in a first step of the interconnected steps and information generated from the LLM 180 in the first step may be incorporated into a LLM call at a second step, and so on. In some cases, at each of the steps, the LLM 180 may be called multiple times, adding further information or context, to fine-tune an output from the LLM 180.

Initially an event associated with the contact 210 may be detected by an event detection component 212 of the AI agent 135. The event may be the receipt of an email, a text message, a telephone call, a social media posting, data input into an input field at a webpage, a query or message input at a user interface associated with the AI agent 135, a scheduling event (e.g., a previously scheduled time-based or date-based event), a continuation of a previous conversation, or any other triggering event associated with the contact 210. In some cases, the event detection component 212 may autonomously detect or generate an event, based on information associated with the contact 210 (e.g., a scheduling event), previous interactions with the contact 210, a purchase history associated with the contact 210, a web browsing/search history associated with the contact 210, or the like. For instance, the event detection component 212 may determine that a sale exists on an item that the contact 210 has been performing a web search for and the event detection component 212 may autonomously trigger an event associated with the sale item. The event (e.g., a message) may be the start of a new interaction (e.g., a conversation) with the AI agent 135 or may be a continuation of an existing one. In some cases, the event may trigger the AI agent 135 to initiate (e.g., unprompted by the contact 210) an outbound communication with the contact 210. In one example, the first organization may be a medical spa business that implements the AI agent service 120. In this example, the AI agent 135 may detect an event related to a contact 110 searching on a website associated with the first organization for facial services and various store locations.

In some cases, when an event is detected, the AI agent 135 may determine whether the detected event satisfies a filtering policy, a discontinuation policy, or a combination thereof. For instance, the first organization may maintain one or more policies that govern when to initiate or terminate conversations with a contact 210. For example, the first organization may maintain one or more filtering policies that include rules specifying when a detected event should be processed by the AI agent 135. Accordingly, the one or more filtering policies may be applied to the detected event to determine whether the event should be processed by the AI agent 135 and a conversation initiated. The filtering policies may include policies that validate a source of an event, consider timing constraints (e.g., business hours associated with the first organization utilizing the AI agent 135), consider a type of event, and the like. For instance, following through with the previous example, the AI agent 135 may validate a source of the web browsing event, such as to determine whether the event is initiated from a valid website associated with the first organization. In some cases, the filtering policies may be based on lead entry points, automations, re-opened conversations, an amount of time since the contact 210 or the AI agent 135 last responded, whether the interaction has been escalated to a human, etc. If the detected event passes the filtering policies, a conversation or other interaction with the contact 210 may proceed.

The first organization may additionally maintain one or more discontinuation policies that include rules indicating when a conversation or interaction with the contact 210 should proceed or be terminated. Accordingly, after applying the one or more filtering policies, the one or more discontinuation policies may additionally be applied. The discontinuation policies may include policies that determine whether any malicious prompt injection attempts have occurred, whether there have been any violations of any business policies, such as terms of service violation, content moderation violations, or the like, whether the conversation or interaction has ended, or the like. In some cases, the discontinuation policies may be based on a threshold quantity of interactions, a threshold duration of time, etc. If the detected event passes the discontinuation policies, the conversation or other interaction with the contact 210 may proceed. In some cases, the AI agent 135 may utilize an LLM 180 to apply the filtering or discontinuation policies. In some cases, the LLM 180 may be tuned or conditioned for the filtering or discontinuation policies. For instance, information associated with the detected event (e.g., as content of a user message or query) may be input to the LLM 180, and the LLM 180 may determine whether the detected event passes the filtering or discontinuation policies.

A dynamic classification component 214 of the AI agent 135 may analyze the detected event and may classify the detected event. For instance, the dynamic classification component 214 may utilize information associated with the detected event (e.g., type of event, content of a message, etc.) and information associated with the first organization (e.g., an industry associated with the first organization, one or more rules or policies associated with the first organization, etc.) to classify the detected event. In some implementations, the classification may be performed by the one or more LLMs 180. For instance, the dynamic classification component 214 may provide an input to an LLM 180 (e.g., a prompt) that includes information associated with the detected event and information associated with the first organization, and the LLM 180 may output a classification. For example, the prompt may include the available classifications for the first organization and information associated with the detected event. Following through with the previous example, the dynamic classification component 214 may input information to the LLM 180 related to the detected web browsing event, such as one or more web pages or items on the web pages that the contact 210 was viewing, and related to the first organization, such as an industry associated with the first organization. The LLM 180 in this case may output a classification such as “medspa services.”

In some cases, the first organization may define rules or policies that may be used by the AI agent 135 in making classification decisions. The first organization may additionally define various topic areas (e.g., which in some cases may correspond to business departments of the first organization) used to classify the events. In some implementations, the rules, policies, or the various topic areas may be standard topic areas defined by for organizations of the specific industry type served by the AI agent 135. Accordingly, the dynamic classification component 214 may provide input to the LLM 180 that includes the LLM-generated classification of the detected event, information associated with the detected event, and information associated with the defined rules or policies, and the LLM 180 may output one or more of the various topic areas, which the dynamic classification component 214 may utilize to further classify the event to an appropriate topic area. Following through with the previous example, the dynamic classification component 214 may input to the LLM 180 the determined “medspa services” classification, information associated with the detected web browsing event, such as one or more web pages or items on the web pages that the contact 210 was viewing, and any classification rules used by the first organization, and the LLM 180 may output a topic areas such as “facial services” and “spa locations.”

In some cases, based on one or more of the event content (e.g., content of a conversation, message, user query, or the like), the event classification, and the defined rules or policies, the LLM 180 may additionally determine and output an intended or desired outcome of the interaction with the contact 210. For instance, an intended outcome may be related to resolving a customer query, scheduling a service, completing a sale, or the like. Accordingly, the AI agent 135 may provide, as input to the LLM 180, information associated with the detected event (e.g., content of a conversation, message, user query, etc.), the event classification, possible outcomes (e.g., from a list of outcomes associated with the first organization), the defined rules or policies, etc., and the LLM 180 may determine an intended outcome of the interaction with the contact 210. Following through with the previous example, the LLM 180 may determine that an intended outcome of the detected web browsing event is to schedule a facial for the contact 210 at a location near where the contact 210 lives.

In some cases, the LLM 180 may use the intended outcome in making the additional determinations of one or more appropriate topic areas for classifying the event or may further fine-tune an existing determination of one or more appropriate topic areas. In some instances, the detected event may be classified into multiple topic areas. In some cases, the LLM 180 may be called multiple times (e.g., with additional information) to fine-tune the classification or topic area output by the LLM 180.

Based on the classification or topic areas output by the LLM 180 and the resulting classification determination, a playbook selection component 216 of the AI agent 135 may select one or more playbooks from a playbook library based on one or more rules defined by the first organization associating different playbooks to different topic areas, based on a domain or industry associated with the first organization, and based on the intended outcome of the interaction with the contact 210 as determined by the LLM 180. The playbook library may be maintained in a database associated with the AI agent service 120, such as the playbook library 220, which may be an example of the database 145 of FIG. 1, and may include a plurality of different playbooks. The playbooks may be templated sets of domain-specific instructions (e.g., code or pseudo-code executable by an interpreter) that include conditional logic (e.g., control flow branching instructions), formatting instructions, and rules-based instructions for handling various scenarios within the context of a specific domain or industry. In some cases, the playbooks may further include business rules, response templates, prompt templates, and decision trees that are relevant or tailored to different topic areas and intended outcomes. For instance, the playbooks may include different sets of domain-specific instructions for different scenarios, such as for different events, different topic areas, different contexts, or the like. Accordingly, the domain-specific instructions for a particular scenario may include instructions on information to be collected or to be provided in responding to a detected event, instructions on a communication style and tone to be used in responding to a detect event, instructions on particular prompts to utilize in different scenarios, such as when an event requires escalation or human interaction, or the like. The playbook instructions and rules may guide the AI agent 135 in responding to specific scenarios associated with the detected event and, thus, may guide the interactions with the contact 210 towards an appropriate response to the detected event (e.g., a response to a message), as well as towards the intended outcome of the conversation. In some examples, one or more branches of the playbook may be conditioned on one or more results of a prior call to the LLM 180 (e.g., intended outcome, classification, topic area(s)), information associated with the detected event, information extracted from the current conversation, or context related to the contact. In some implementations, the playbooks may be implemented as Python or Jinja-templated files.

Accordingly, the playbook selection component 216 may select a playbook that may be relevant to the topic area under which the detected event was classified and that may steer the interactions with the contact 210 towards the intended outcome. For example, continuing with the previous example, based on the determined topic areas of “facial services” and “spa locations” the playbook selection component 216 may select playbooks “get facial pricing,” “get most popular facials,” and “get store locations.” In some implementations, when there may be ambiguity about a playbook selection, an LLM 180 may be utilized to resolve the ambiguity. For instance, one or more of information associated with the detected event (e.g., content of a conversation, message, user query, etc.), the domain associated with the first organization, the classification determination, the intended outcome generated by the LLM 180 in the previous step, or a description of the available playbooks may be input to the LLM 180, and the LLM 180 may make a determination about an appropriate playbook selection and output one or more playbook selections.

Additionally, based on the classification, a tool integration component 218 of the AI agent 135 may (e.g., before, after, or concurrent with the playbook selection) identify, retrieve (e.g., from the database 145), and activate one or more tools (e.g., code or pseudocode) necessary to respond to the detected event and to steer the interactions with the contact 210 towards the intended outcome. In some cases, the selected playbook may indicate one or more tools that should retrieved (e.g., may include logic to select one or more tools based on information extracted from the current conversation or context related to the contact). The tool integration component 218 may incorporate action-oriented and knowledge-oriented tools into the interaction flow. The action-oriented tools may enable the AI agent 135 to perform tasks such as scheduling appointments or triggering notifications, while the knowledge-oriented tools may enable the AI agent 135 to access and utilize information from sources, such as databases (e.g., by querying a database for product information), frequently asked questions (FAQs), or company handbooks. In some instances, when a tool is identified for responding to the detected event, an LLM 180 may be called to evaluate whether the tool should be used based on the detected event (e.g., based on current conversation context) and the tool's functionality. Accordingly, information associated with the detected event (e.g., a content of the current conversation) and information associated with the identified tool may be input to the LLM 180 and the LLM 180 may output a determination of whether the tool is applicable for the detected event (e.g., for the current state of the conversation) and should be utilized. If it is determined that the identified tool is applicable and should be utilized, an LLM 180 may be further called to extract the necessary parameters required for invoking the tool. The parameters may be extracted from the content of the current conversation or other context relevant to the conversation. For example, the parameters may include scheduling dates and times, specific product or service details, user-provided information, etc. The tool may then be activated by executing the tool with the extracted parameters. For example, this may involve querying one or more databases, retrieving information such as business hours, inventory information, or the like, performing calculations, etc. Continuing with the previous example, the tools may retrieve a listing of facial services provided by the first organization and corresponding prices, a listing of addresses of store locations associated with the first organization, and may analyze various information associated with the first organization to determine the particular facial services that are currently the most popular. In some cases, the tools themselves may make internal calls to an LLM 180 or invoke other tools. For example, a tool may verify whether a requested service is offered by the first organization using an internal call to an LLM 180.

An instruction compilation component 222 of the AI agent 135 may evaluate any conditional logic associated with the selected playbooks given the current context (e.g., the current state of the conversation, one or more results of a prior call to the LLM 180, information associated with the detected event, information extracted from the current conversation, or context related to the contact), to determine a set of playbook instructions applicable for the current context. The AI agent may then compile a prompt for the LLM 180 to generate a response to the detected event. The prompt may include the determined set of applicable playbook instructions, any outputs from the activated and executed tools, and data associated with the event (e.g., as a content of a conversation, which may include portions of the conversation from previous interactions with the contact 210 or from one or more other communications channels used by the contact 210 to interact with the AI agent 135). In some cases, the instruction compilation component 222 may resolve any conflicts between different instructions and may prioritize the most relevant information. The instruction compilation component 222 may distill complex business logic into clear, actionable instructions for the AI agent 135.

A context integration component 224 of the AI agent 135 may combine the compiled playbook instructions with contextual information associated with the detected event. For instance, the context integration component 224 may determine context such as a current date and time; information associated with the contact 210, such as a name associated with the contact 210, a location of the contact 210, etc.; an environmental state, such as weather conditions at a location of the contact 210, etc.; information associated with the first organization, such as an industry associated with the first organization, business hours, current promotions, etc.; a communications channel associated with the detected event; previous interactions associated with the current message or the contact 210; communications channels associated with the previous interactions; a state of the current interaction; or any other contextual information. The determined contextual information may be integrated with the compiled playbook instructions. For example, continuing with the previous example, the context integration component 224 may determine a general location associated with the contact 210. For instance, the context integration component 224 may use an IP address, GPS, Wi-Fi network information, cookies or other tracking data, etc. associated with a device used by the contact 210 to connect with the website, etc. to determine a general location, and the general location may be used to ultimately narrow down store locations to be retrieved.

A response generation component 226 of the AI agent 135 may use the compiled playbook instructions that are integrated with the contextual information to generate the prompt to be input to the LLM 180. The prompt may include information associated with the compiled playbook instructions, the contextual information, the detected event, the intended outcome, or a combination thereof. For instance, when the detected event is a user message that is associated with a conversation between the AI agent 135 and a contact 210, the prompt may include some portion of the content of the user message or some portion of the content of the conversation. For instance, a history of conversations (e.g., current and previous communications via the current communications channel or one or more other communications channels) with the contact 210 may be maintained (such as in the database 145), and in some cases, portions of such communications may be included in the prompt as additional context. The prompt may be generated to request from the LLM 180 a tailored, appropriate response that is responsive to an inquiry of the contact 210 and that additionally guides an interaction with the contact 210 towards the intended outcome (e.g., to guide the conversation towards a particular outcome). In some cases, the prompt may be multi-part. For example, a conditioning prompt may provide at least portions of the contextual information and the detected event, and then a second prompt may request a response that is tailored for generating a response to a message that will advance the conversation towards the intended outcome. Accordingly, the response generation components 226 may input the prompt to the LLM 180, and the LLM 180 may generate a response that adheres to the playbook instructions while being both responsive to the detected event (e.g., a query or message from the contact 210) and advancing a goal of the interaction (e.g., the intended outcome). For example, following through with the previous example, the response generation component 226 may generate a response such as “Hi, I noticed you have been browsing for facial services. Below is a listing of some of our most popular facial services and their prices. We have 5 store locations in your area. Would you like to schedule an appointment at one of our locations?”

In some cases, the response generation component 226 may determine whether the generated response needs further refinement, and if so, whether further information is necessary for such refinement. In such cases, the AI agent 135 may update the context based on the generated response and any new information, reevaluate the playbook conditions (e.g., via the instruction compilation component 222), and re-compile a prompt based on an updated set of playbook instructions. The re-compiled prompt may be input to the LLM 180 for a refined response. In some cases, the AI agent 135 may make multiple such calls to the LLM 180 to refine the generated response.

After generation of the response, a human oversight component 228 of the AI agent 135 may provide a mechanism for involving a human operator 250 when necessary, either for oversight, handling of complex queries, or managing other scenarios that may require human intervention. For instance, the human oversight component 228 may analyze the generated response to determine whether the response should be flagged for review by a human operator 250 of the first organization. The human oversight component 228 may make such determinations based on predefined criteria, business rules, or detected edge cases. In some cases, the determinations may additionally be based on the particular detected event, a current state of the interaction with the contact 210, or the intended outcome. This may allow for quality control and the handling of complex interaction scenarios. In such cases, the human oversight component 228 may trigger an escalation to a human operator 250 and may route the detected event to the human operator 250. In some cases, the human oversight component 228 may utilize an LLM 180 to determine whether to escalate to the human operator 250 based on the predefined criteria, the business rules, the detected edge cases, the detected event, a current state of the interaction with the contact 210, the intended outcome, or the like. In some cases, the LLM 180 may further output one or more proposed responses to be provided to the human operator 250 to further assist the human operator 250 in responding to the event.

After review of the generated response, a response action component 230 of the AI agent 135 may determine one or more actions to perform based on the generated response. For instance, the one or more actions may include logging an interaction and updating a state of the interaction (e.g., a state of the conversation) to reflect the last interaction. In some cases, the state of the interaction may be based on whether the intended outcome has been achieved. The one or more actions may include outputting the generated response to the contact 210. For example, following through with the previous example, the response action component 230 may output the previously generated resource “Hi, I noticed you have been browsing for facial services. Below is a listing of some of our most popular facial services and their prices. We have 5 store locations in your area. Would you like to schedule an appointment at one of our locations?” In some cases, the generated response may be a query soliciting additional information to steer the interaction towards the intended outcome. The one or more actions may include determining whether there are any queries unanswered by the contact 210 that may be necessary for arriving at the intended outcome. The one or more actions may include scheduling an event, such as a calendar event, associated with the interaction or the contact 210. The one or more actions may include determining a communications channel to use to output the generated response. In some cases, the determination may be based on a current communications channel used by the contact 210, a previous communications channel used by the contact 210, a communications channel requested by the contact 210 for the response, a communications channel selected based on a business rule or policy associated with first organization. The one or more actions may include terminating a conversation, such as when the intended outcome has been achieved.

As the interactions with the contact 210 progress, a continuous adaptation component 232 of the AI agent 135, may continuously evaluate and reevaluate, in real-time, the context (such as by updating existing contextual information or retrieving additional contextual information and the content associated with interactions (e.g., the content of user messages or other detected events) and may dynamically switch to different playbooks or activate different tools as needed to ensure that the AI agent 135 remains responsive to evolving conversation dynamics. For instance, after each action performed by the AI agent 135 (e.g., after outputting a generated response by the response action component 230), updated or additional contextual information may be collected, which may be coupled with further content from a next user message from the contact 210 or other detected event, and the process may again perform dynamic classification, such that the dynamic classification component 214 again makes a call to the LLM 180, inputting the updated information (e.g., updated or additional contextual information, content associated with a next user message or event, etc.), which may result in an updated classification, playbook selection, or tool activation, In this way, the AI agent 135 may ensure that the conversation progresses as a dialog, with increasing levels of specificity with respect to the responses to user queries and to the intended outcome.

In accordance with aspects of the present disclosure, the AI agent service 120 and the various AI agents 135 may be dynamically adaptable to various business domains and conversation types by modifying the playbook library and tool integrations, such as by adding new playbooks and tools or modifying existing ones as the needs of the organization change. By using playbooks (e.g., industry-specific playbooks or those defined by an organization) and corresponding instructions, AI agent generated responses may remain consistent with an organization's policies and best practices. Moreover, the modular nature of the playbooks and tool integrations may allow for simplified expansion of capabilities of the AI agent service 120 or the various AI agents 135 as new business needs arise. Organizations may, as a result, maintain fine-tuned control over AI agent behavior through carefully-crafted playbooks, reducing the risk of inappropriate or off-brand responses. By automating routine interactions, while providing mechanisms for human intervention in complex cases, a balance between AI efficiency and human expertise may be optimized. The framework associated with the AI agent service 120 and the various AI agents 135 may provide a structured, yet flexible, approach to managing AI interactions, enabling organizations to leverage the power of LLMs 180, while ensuring that an AI agent 135 operates within the bounds of specific business requirements and objectives, thereby improving performance, consistency, and reliability of such AI agents 135.

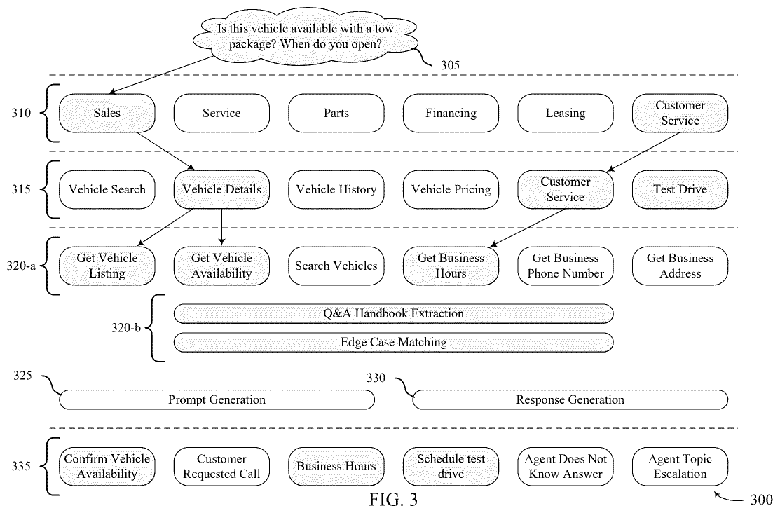

FIG. 3 shows an example of a process flow 300 that supports a framework for an industry-specific AI agent in accordance with aspects of the present disclosure. The process flow 300 may implement, or be implemented by, aspects of the communications environment 100 described with reference to FIG. 1 or the process flow 200 described with reference to FIG. 2. For instance, the process flow 300 may describe a framework for utilizing an AI agent (e.g., the AI agent 135 provided by the AI agent service 120 of FIG. 1) by, for example, a first organization to interact with the contact 210 described with reference to FIG. 2. The process flow 300 may involve a series of interconnected steps performed by the AI agent 135 when an event, such as an inbound message, is detected. In some instances, a reference to the AI agent 135 performing a particular process or step in the process flow 300 may also involve use of one or more LLMs (e.g., LLM 180 of FIG. 1) by the AI agent 135 in performing the particular process or step.

In one example, the AI agent 135 (e.g., the event detection component of FIG. 2) may detect an event, such as an inbound message 305 from contact 210. The AI agent 135 may analyze the inbound message 305 to determine information associated with the inbound message 305, such as a source communications channel, a status of an interaction or conversation state associated with the inbound message 305 or the contact 210, a content of the inbound message 305, etc. In this example, the AI agent 135 may analyze the inbound message 305 and determine that the content is related to vehicle details and availability and business hours. The AI agent 135 may also determine that the source communications channel for the inbound message 305 is an email that was initiated from a website page associated with the first organization and that the inbound message 305 is also a follow-up of a telephone call the contact 210 initiated with the first organization on a previous day. In addition to analyzing the content of the inbound message 305, the AI agent 135 may determine or retrieve information associated with the first organization, such as an industry associated with the first organization, rules or policies associated with classifying the inbound message 305, rules or policies associated with classification the inbound message 305, rules or policies associated with determining an intended outcome for the interaction with the contact 210, or the like. The AI agent service 120 may determine that the first organization is associated with an automotive industry. Based on the determined industry, classification rules or policies, and the content of the inbound message 305 (and in some cases some portion of an associated conversation history), the inbound message 305 may be classified. For example, the AI agent 135 may input the determined industry, classification rules or policies, available classifications, and the content of the inbound message 305 into an LLM, and the LLM may output one or more classifications for a detected event. For instance, in this example, the inbound message 305 may be classified as “sales-related” and “customer service-related.”

Based on the classification, the AI agent 135 (e.g., the dynamic classification component 214 of FIG. 2) may determine one or more topic areas of a plurality of topic areas 310 for further classifying the inbound message 305. In some cases, the topic areas may be based on the determined or retrieved rules or policies defined for making classification decisions. The AI agent 135 may use the rules and policies together with the classification of the inbound message 305 as input to an LLM, and the LLM may generate and output one or more topic areas associated with the inbound message 305, which may be used by the AI agent 135 to classify the inbound message 305. For instance, in this example, based on output of one or more topic areas from the LLM, the AI agent 135 may determine to classify the inbound message 305 as both “Sales” (e.g., to address the inquiry related to the vehicle availability) and “Customer Service” (e.g., to address the inquiry related to when the business is open). In some cases, based on the classification determination and the determined or retrieved rules for an intended outcome determination, the LLM may additionally determine and output an intended outcome for the interaction with the contact 210. For instance, in this example, the LLM may determine that the intended outcome is to have the contact 210 schedule a test drive.

Based on the classification, the AI agent 135 (e.g., the playbook selection component 216 of FIG. 2) may select one or more playbooks from a plurality of playbooks 315. For instance, the AI agent 135 may select one or more playbooks that may be relevant to the topic areas under which the inbound message 305 was classified and that may steer the interactions with the contact 210 towards the intended outcome. In some examples, the first organization may define one or more rules associating the different topic areas with particular playbooks, and the AI agent 135 may select the one or more playbooks associated with the one or more topic areas determined by the LLM. In some implementations, when ambiguity exists about a playbook selection, the LLM may be utilized to resolve the ambiguity. For instance, the classification determination and intended outcome generated by the LLM may be input to the LLM, and the LLM may make a determination about an appropriate playbook to select. In this example, based on the determination to classify the inbound message 305 as “Sales” and “Customer Service,” and the determination that the intended outcome is to have the contact 210 schedule a test drive, the AI agent 135 or the LLM may select the playbooks “Vehicle Details” and “Customer Service,” which may be related to the selected topic areas of “Sales” and “Customer Service,” respectively, and may also select the playbook “Test Drive,” which may be related to the intended outcome of having the contact 210 schedule a test drive.

The AI agent 135 (e.g., tool integration component 218 of FIG. 2) may additionally identify, retrieve, and activate one or more tools (e.g., action-oriented or knowledge-oriented tools) of a plurality of tools 320 necessary to respond to the inbound message 305 and to steer the interactions with the contact 210 towards the intended outcome. In some cases, the AI agent 135 may select tools from among optional tools 320-a or default tools 320-b. For instance, the optional tools 320-a may be tools that are dynamically selected based on the selected playbooks, while the default tools 320-b may be tools that are domain and topic agnostic and may be used regardless of a selected playbook. For instance, in this example, the AI agent 135 may identify, retrieve, and activate the “Get Vehicle Listing,” “Get Vehicle Availability,” and “Get Business Hours,” related to the selected playbooks “Sales” and “Customer Service. ” The tools may be used to retrieve information for responding to a query from the contact 210. In this example, the “Get Vehicle Listing” and “Get Vehicle Availability” may be used to retrieve information indicating vehicles that are available and a listing of their various features. The “Get Business Hours” tools may be used to retrieve information associated with the first organization's business hours.

The AI agent 135 (e.g., the instruction compilation component 222 of FIG. 2) may compile instructions associated with the selected playbooks and the activated tools to generate task-specific natural language text (e.g., a prompt 325) for the LLM. The AI agent 135 (e.g., the context integration component 224 of FIG. 2) may retrieve contextual information associated with the inbound message 305, the contact 210, or a history of the interactions associated with the inbound message 305 or the contact 210. For example, the contextual information may include a current date and time; information associated with the contact 210, such as a name associated with the contact 210, a location of the contact 210, etc.; an environmental state, such as weather conditions at a location of the contact 210, etc.; information associated with the first organization, such as an industry associated with the first organization, business hours, current promotions, etc.; a communications channel associated with the detected event; previous interactions associated with the current message or the contact 210; communications channels associated with the previous interactions; a state of the current interaction; or any other contextual information related to an interaction with the contact 210. For instance, in this example, the AI agent 135 may retrieve contextual information associated with a current date and time, a location of the contact 210, and a web page from which the contact 210 initiated the email. For instance, a response to the contact's query related to “When do you open?” may depend on the context. For example, if the query was received on a Friday evening, an appropriate response may be to provide the business hours for the weekend versus the weekday hours if the query was received mid-week. The location of the contact 210 may be relevant as well, such as to determine a particular business location (such as when there are multiple) to provide the business hours for. In this instance, it may be appropriate to provide business hours to the location nearest to the location of the contact 210. Additionally, to understand what vehicle the contact 210 is referring to in the query “Is this vehicle available with a tow package?,” the web page from which the contact 210 initiated the email may provide an indication of a vehicle that the contact 210 was viewing (e.g., on the web page). Further, in this example, the content of the related telephone call that the contact 210 previously initiated to the first organization may be provided as context as well to have an understanding of what information was previously provided to the contact 210, such as to reduce redundancy and ensure consistency of responses. The AI agent service 120 may combine the determined contextual information with the compiled instructions.

The AI agent 135 (e.g., the response generation component 226 of FIG. 2) may use the compiled instructions integrated with the contextual information to generate a prompt 325 to be input to the LLM 180. The prompt may be generated in a manner that causes the LLM to output a response to the inbound message 305 that is responsive to the contact's query and that additionally helps to advance the conversation towards the intended outcome. As such, in this example, the prompt may include information associated with the content of the inbound message 305 and content of the previous telephone call, contextual information, such as the web page from which the email from the contact 210 was initiated, the location of the user, and the current date and time, and may additionally include the intended outcome. The prompt 325 may be input to the LLM, and the LLM may generate a response 330 that adheres to playbook guidelines (e.g., business rules set forth by the playbook) while being both responsive to the inbound message 305 and advancing a goal of the interaction towards the intended outcome. For instance, the generated response may provide an answer to the questions “Is this vehicle available with a tow package?” and “When do you open?” and may include a follow-up response asking the contact 210 “Yes! A tow package is available for this vehicle, and costs $XXX extra. We open tomorrow at 10 am. Would you like to come in tomorrow for a test drive?”

The AI agent 135 (e.g., the response action component 230 of FIG. 2) may, thereafter, determine one or more actions 335 to perform based on the generated response 330. For instance, the AI agent 135 may update a state of the conversation associated with the inbound message 305 and may output the generated response 330 to the contact 210. In some cases, the AI agent 135 may determine, based on one or more rules or policies, a destination communications channel to utilize to output the generated response 330. For instance, the AI agent 135 may determine, based on the one or more rules or policies, to output the generated response 330 via the same communications channel as the source communications channel, in this example, to email. In this example, the AI agent 135 may additionally detect a second inbound message, such as a reply to the generated response “Would you like to come in tomorrow for a test drive?” The AI agent 135, in this case, may classify the new inbound message, select different playbooks, activate different tools, and collect additional contextual information, During each of these steps, the AI agent 135 may pass information collected in previous iterations of the communication with the contact 210 to the LLM to ensure that the AI agent 135 continues the dialog with the contact 210 in a way that advances the conversation towards the intended outcome. For instance, if the contact 210 replies “Yes, I would like to come in at 10 am for a test drive,” the AI agent service 120 may schedule the contact 210 for a test drive, which may trigger a determination that the intended outcome has been achieved, and a state of the interaction may be indicated as “closed.”

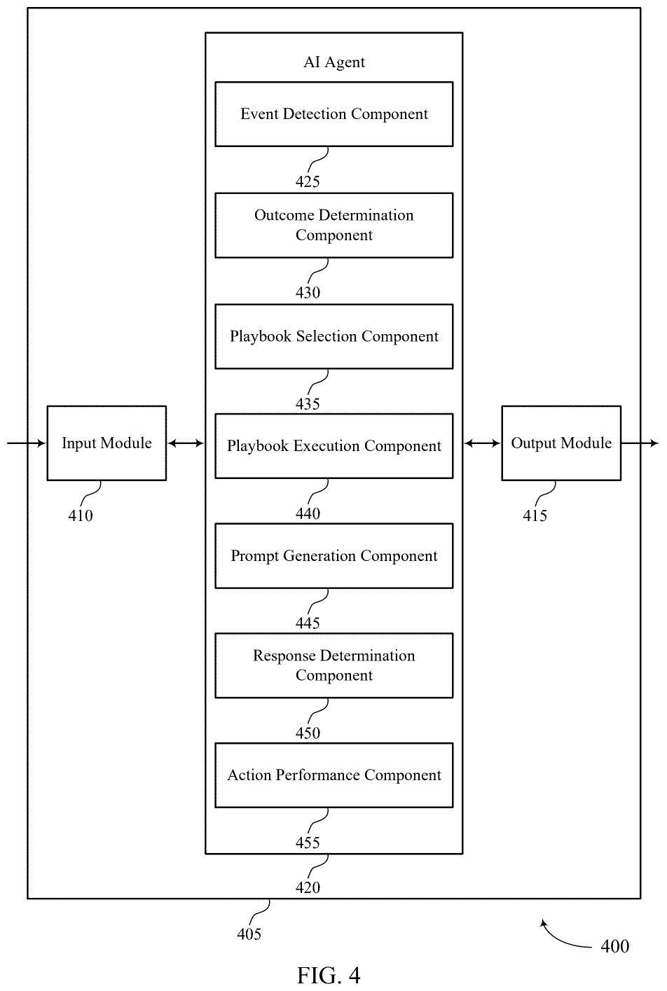

FIG. 4 shows a block diagram 400 of a device 405 that supports a framework for an industry-specific AI agent in accordance with aspects of the present disclosure. The device 405 may include an input module 410, an output module 415, and an AI agent 420. The device 405, or one or more components of the device 405 (e.g., the input module 410, the output module 415, the AI agent 420), may include at least one processor, which may be coupled with at least one memory, to support the described techniques. Each of these components may be in communication with one another (e.g., via one or more buses).

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the AI agent 420 to support a framework for an industry-specific AI agent.

The output module 415 may manage output signals for the device 405. For example, the output module 415 may receive signals from other components of the device 405, such as the AI agent 420, and may transmit these signals to other components or devices. In some examples, the output module 415 may transmit output signals for display in a user interface, for storage in a database or data store, for further processing at a server or server cluster, or for any other processes at any number of devices or systems.

For example, the AI agent 420 may include an event detection component 425, an outcome determination component 430, a playbook selection component 435, a playbook execution component 440, a prompt generation component 445, a response determination component 450, an action performance component 455, or any combination thereof. In some examples, the AI agent 420, or various components thereof, may be configured to perform various operations (e.g., receiving, monitoring, transmitting) using or otherwise in cooperation with the input module 410, the output module 415, or both. For example, the AI agent 420 may receive information from the input module 410, send information to the output module 415, or be integrated in combination with the input module 410, the output module 415, or both to receive information, transmit information, or perform various other operations as described herein.

The event detection component 425 may be configured to support detecting an event associated with a contact of a first organization. The outcome determination component 430 may be configured to support identifying, based at least in part on the detected event and a conversation associated with the contact, an intended outcome of the conversation. The playbook selection component 435 may be configured to support selecting, based on the intended outcome and the first organization, a first industry-specific playbook of a set of multiple industry-specific playbooks. The playbook execution component 440 may be configured to support executing one or more steps associated with the first industry-specific playbook, where the one or more steps are selected based on the detected event and the conversation. The prompt generation component 445 may be configured to support generating, based on the first industry-specific playbook, a first prompt that includes first information associated with the detected event, second information obtained based on performance of the one or more steps, and third information associated with the intended outcome. The response determination component 450 may be configured to support obtaining, based at least in part on inputting the first prompt to a first LLM, fourth information associated with a response to the detected event. The action performance component 455 may be configured to support performing, based on the fourth information, one or more actions.

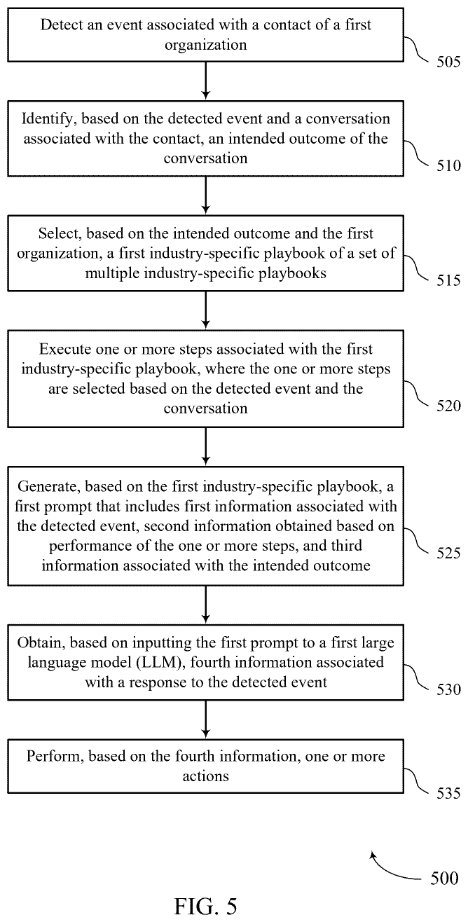

FIG. 5 shows a flowchart illustrating a method 500 that supports a framework for an industry-specific AI agent in accordance with aspects of the present disclosure. The operations of the method 500 may be implemented by a computing device or its components as described herein. For example, the operations of the method 500 may be performed by a computing device as described with reference to FIGS. 1 through 4. In some examples, a computing device may execute a set of instructions to control the functional elements of the computing device to perform the described functions. Additionally, or alternatively, the computing device may perform aspects of the described functions using special-purpose hardware.

At 505, the method may include detecting an event associated with a contact of a first organization. The operations of 505 may be performed in accordance with examples as disclosed herein.

At 510, the method may include identifying, based at least in part on the detected event and a conversation associated with the contact, an intended outcome of the conversation. The operations of 510 may be performed in accordance with examples as disclosed herein.

At 515, the method may include selecting, based on one or more of the detected event, the conversation, the intended outcome, and the first organization, a first industry-specific playbook of a set of multiple industry-specific playbooks. The operations of 515 may be performed in accordance with examples as disclosed herein.

At 520, the method may include executing one or more steps associated with the first industry-specific playbook, where the one or more steps are selected based on the detected event and a state of the conversation. The operations of 520 may be performed in accordance with examples as disclosed herein.

At 525, the method may include generating, based on the first industry-specific playbook, a first prompt that includes first information associated with the detected event, second information obtained based on performance of the one or more steps, and third information associated with the intended outcome. The operations of 525 may be performed in accordance with examples as disclosed herein.

At 530, the method may include obtaining, based at least in part on inputting the first prompt to a first LLM, fourth information associated with a response to the detected event. The operations of 530 may be performed in accordance with examples as disclosed herein.

At 535, the method may include performing, based on the fourth information, one or more actions. The operations of 535 may be performed in accordance with examples as disclosed herein.

The following provides an overview of aspects of the present disclosure:

Aspect 1: A method for utilizing an AI agent, comprising: detecting an event associated with a contact of a first organization; identifying, based at least in part on the detected event and a conversation associated with the contact, an intended outcome of the conversation; selecting, based at least in part on the intended outcome and the first organization, a first industry-specific playbook of a plurality of industry-specific playbooks; executing one or more steps associated with the first industry-specific playbook, wherein the one or more steps are selected based at least in part on the detected event and the conversation; generating, based at least in part on the first industry-specific playbook, a first prompt that comprises first information associated with the detected event, second information obtained based at least in part on performance of the one or more steps, and third information associated with the intended outcome; obtaining, based at least in part on inputting the first prompt to a first LLM, fourth information associated with a response to the detected event; and performing, based at least in part on the fourth information, one or more actions.

Aspect 2: The method of aspect 1, wherein the detected event comprises an email, a text message, a telephone call, a scheduling event, or a previous conversation associated with the contact.

Aspect 3: The method of any of aspects 1 through 2, wherein performing the one or more actions comprises: updating, based at least in part on determining that the intended outcome has been achieved, a state of the conversation to a concluded state; outputting a question to the contact to solicit information to the conversation towards the intended outcome; determining whether a response to an unanswered query output to the contact is needed for arriving at the intended outcome; scheduling a second event associated with the contact; or a combination thereof.

Aspect 4: The method of aspects 1 through 3, further comprising: classifying, using a second LLM and based at least in part on the first information and on information associated with the first organization, the detected event, wherein the first industry-specific playbook is selected further based at least in part on classification of the detected event.

Aspect 5: The method of aspect 4, wherein the second LLM is the same as the first LLM.

Aspect 6: The method of any of aspects 1 through 5, further comprising: determining an industry associated with the first organization, wherein one or more of the first industry-specific playbook or the intended outcome is selected based at least in part on the industry associated with the first organization.

Aspect 7: The method of any of aspects 1 through 6, further comprising: determining contextual information, wherein the contextual information comprises one or more of information associated with an environmental state, a current date, a current time, information associated with the first organization, information associated with the contact, information associated with a client device associated with the contact, information associated with the conversation, a first communications channel associated with the detected event, or a second communications channel associated with the response to the detected event, and wherein the one or more steps are selected further based at least in part on the contextual information.

Aspect 8: The method of aspect 7, wherein the first communications channel comprises email, text, chat, social media, a website input field, or voice call, wherein the conversation is received via the first communications channel, and determining the contextual information comprises determining a portion of the contextual information based on the conversation received via the communications channel.

Aspect 9: The method of any of aspects 7 through 8, further comprising: determining a previous communications channel associated with a previous event associated with the conversation, wherein the previous communications channel is different from the first communications channel, and wherein determining the contextual information comprises determining the contextual information based on a conversation associated with the previous communications channel.

Aspect 10: The method of any of aspects 1 through 9, wherein the one or more steps comprise retrieving and executing one or more activation tools or knowledge tools, and wherein the second information obtained based at least in part on the performance of the one or more steps comprises information retrieved from execution of the one or more activation tools or knowledge tools.

Aspect 11: The method of any of aspects 1 through 10, wherein selecting the first industry-specific playbook is based at least in part on determining that the detected event satisfies a discontinuation policy, a filter policy, or a combination thereof.

Aspect 12: An apparatus comprising one or more memories storing processor-executable code, and one or more processors coupled with the one or more memories and individually or collectively operable to execute the code to cause the apparatus to perform a method of any of aspects 1 through 11.

Aspect 13: An apparatus comprising at least one means for performing a method of any of aspects 1 through 11.

Aspect 14: A non-transitory computer-readable medium storing code the code comprising instructions executable by one or more processors to perform a method of any of aspects 1 through 11.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for utilizing an artificial intelligence (AI) agent, comprising:
detecting an event associated with a contact of a first organization;
identifying, based at least in part on the detected event and a conversation associated with the contact, an intended outcome of the conversation;
selecting, based at least in part on one or more of the detected event, the conversation, the intended outcome, or the first organization, a first industry-specific playbook of a plurality of industry-specific playbooks;
executing one or more steps associated with the first industry-specific playbook, wherein the one or more steps are selected based at least in part on the detected event and the conversation;
generating, based at least in part on the first industry-specific playbook, a first prompt that comprises first information associated with the detected event, second information obtained based at least in part on performance of the one or more steps, and third information associated with the intended outcome;
obtaining, based at least in part on inputting the first prompt to a first large language model (LLM), fourth information associated with a response to the detected event; and
performing, based at least in part on the fourth information, one or more actions.

2. The method of claim 1, wherein the detected event comprises an email, a text message, a telephone call, a scheduling event, or a previous conversation associated with the contact and received via a first communications channel.

3. The method of claim 1, wherein performing the one or more actions comprises:
updating, based at least in part on determining that the intended outcome has been achieved, a state of the conversation to a concluded state;
outputting, via a communications channel, a question to the contact to solicit information to advance the conversation towards the intended outcome;
determining whether a response to an unanswered query output to the contact is needed for arriving at the intended outcome;
scheduling a second event associated with the contact;
routing information associated with the detected event to a human operator based at least in part on one or more of predefined criteria, business rules, or detected edge cases; or
a combination thereof.

4. The method of claim 1, further comprising:
classifying, using a second LLM and based at least in part on the first information and on information associated with the first organization, the detected event, wherein the first industry-specific playbook is selected further based at least in part on classification of the detected event.

5. The method of claim 4, wherein the second LLM is the same as the first LLM.

6. The method of claim 1, further comprising:
determining an industry associated with the first organization, wherein one or more of the first industry-specific playbook or the intended outcome is selected based at least in part on the industry associated with the first organization.

7. The method of claim 1, further comprising:
determining contextual information, wherein the contextual information comprises one or more of information associated with an environmental state, a current date, a current time, information associated with the first organization, information associated with the contact, information associated with a client device associated with the contact, information associated with the conversation, a first communications channel associated with the detected event, or a second communications channel associated with the response to the detected event, and wherein the one or more steps are selected further based at least in part on the contextual information.

8. The method of claim 7, wherein the first communications channel comprises email, text, chat, social media, a website input field, or voice call, wherein the conversation is received via the first communications channel, and wherein determining the contextual information comprises determining a portion of the contextual information based on the conversation received via the communications channel.

9. The method of claim 7, further comprising:
determining a previous communications channel associated with a previous event associated with the conversation, wherein the previous communications channel is different from the first communications channel, and wherein determining the contextual information comprises determining the contextual information based on a conversation associated with the previous communications channel.

10. The method of claim 1, wherein the one or more steps comprise retrieving and executing one or more activation tools or knowledge tools, and wherein the second information obtained based at least in part on the performance of the one or more steps comprises information retrieved from execution of the one or more activation tools or knowledge tools.

11. The method of claim 1, wherein selecting the first industry-specific playbook is based at least in part on determining that the detected event satisfies a discontinuation policy, a filter policy, or a combination thereof.

12. An apparatus, comprising:
one or more memories storing processor-executable code; and
one or more processors coupled with the one or more memories and individually or collectively operable to execute the code to cause the apparatus to:
detect an event associated with a contact of a first organization;
identify, based at least in part on the detected event and a conversation associated with the contact, an intended outcome of the conversation;
select, based at least in part on one or more of the detected event, the conversation, the intended outcome, and the first organization, a first industry-specific playbook of a plurality of industry-specific playbooks;
execute one or more steps associated with the first industry-specific playbook, wherein the one or more steps are selected based at least in part on the detected event and the conversation;
generate, based at least in part on the first industry-specific playbook, a first prompt that comprises first information associated with the detected event, second information obtained based at least in part on performance of the one or more steps, and third information associated with the intended outcome;
obtain, based at least in part on inputting the first prompt to a first large language model (LLM), fourth information associated with a response to the detected event; and
perform, based at least in part on the fourth information, one or more actions.

13. The apparatus of claim 12, wherein the detected event comprises an email, a text message, a telephone call, a scheduling event, or a previous conversation associated with the contact and received via a first communications channel.

14. The apparatus of claim 12, wherein, to perform the one or more actions, the one or more processors are individually or collectively operable to execute the code to cause the apparatus to:
update, based at least in part on a determination that the intended outcome has been achieved, a state of the conversation to a concluded state;
output, via a communications channel, a question to the contact to solicit information to advance the conversation towards the intended outcome;
determine whether a response to an unanswered query output to the contact is needed for arriving at the intended outcome;
schedule a second event associated with the contact;
route information associated with the detected event to a human operator based at least in part on one or more of predefined criteria, business rules, or detected edge cases; or
a combination thereof.

15. The apparatus of claim 12, wherein the one or more processors are individually or collectively further operable to execute the code to cause the apparatus to:
classify, using a second LLM and based at least in part on the first information and on information associated with the first organization, the detected event, wherein the first industry-specific playbook is selected further based at least in part on classification of the detected event.

16. The apparatus of claim 15, wherein the second LLM is the same as the first LLM.

17. The apparatus of claim 12, wherein the one or more processors are individually or collectively further operable to execute the code to cause the apparatus to:
determine an industry associated with the first organization, wherein one or more of the first industry-specific playbook or the intended outcome is selected based at least in part on the industry associated with the first organization.

18. The apparatus of claim 12, wherein the one or more processors are individually or collectively further operable to execute the code to cause the apparatus to:
determine contextual information, wherein the contextual information comprises one or more of information associated with an environmental state, a current date, a current time, information associated with the first organization, information associated with the contact, information associated with a client device associated with the contact, information associated with the conversation, a first communications channel associated with the detected event, or a second communications channel associated with the response to the detected event, and wherein the one or more steps are selected further based at least in part on the contextual information.

19. The apparatus of claim 18, wherein the first communications channel comprises email, text, chat, social media, a website input field, or voice call, wherein the conversation is received via the first communications channel, and wherein, to determine the contextual information, the one or more processors are individually or collectively operable to execute the code to cause the apparatus to determine a portion of the contextual information based on the conversation received via the first communications channel.

20. A non-transitory computer-readable medium storing code, the code comprising instructions executable by one or more processors to:
detect an event associated with a contact of a first organization;
identify, based at least in part on the detected event and a conversation associated with the contact, an intended outcome of the conversation;
select, based at least in part on one or more of the detected event, the conversation, the intended outcome, and the first organization, a first industry-specific playbook of a plurality of industry-specific playbooks;
execute one or more steps associated with the first industry-specific playbook, wherein the one or more steps are selected based at least in part on the detected event and the conversation;
generate, based at least in part on the first industry-specific playbook, a first prompt that comprises first information associated with the detected event, second information obtained based at least in part on performance of the one or more steps, and third information associated with the intended outcome;
obtain, based at least in part on input of the first prompt to a first large language model (LLM), fourth information associated with a response to the detected event; and
perform, based at least in part on the fourth information, one or more actions.
